(19) United States
(12) Patent Application Publication
(10) Pub. No.: US 2025/0035145 A1
(43) Pub. Date: Jan. 30, 2025

(54) MODULAR STRUCTURE WITH SNAP-IN ASSEMBLY

(71) Applicant: Manuel Artola Angeles, Barcelona (ES)

(72) Inventor: Manuel Artola Angeles, Barcelona (ES)

(21) Appl. No.: 18/715,879

(22) PCT Filed: Sep. 22, 2022
(86) PCT No.: PCT/ES2022/070607

§ 371 Date: Jun. 3, 2024

(30) Foreign Application Priority Data
Dec. 3, 2021 (ES) U202132406

(51) Int. Cl. F16B 12/26; A47B 47/00

(52) U.S. Cl. CPC F16B 12/26; A47B 47/0016

(57) ABSTRACT

A modular structure with snap-in assembly includes: one or more modular parts (2) to be joined, that possess, at least, one perforation (20) or one protrusion (13) located close to one of its edges (21); and one or more assembling elements (1) provided with, at least, one recess (10) with, at least, one protrusion (13) or an internal perforation (20) in which the perforation (20) or the protrusion (13) of the modular part or parts (2) complementarily fit when inserting it by the edge (21) in the said recess (10), so that the complementary fitting of the protrusion (13) in the perforation (20) allows to join the part or parts (2) by snap-in to the assembling element or elements (1) without using tools.

### OBJECT OF THE INVENTION

The invention, as stated in the title of this specification, refers to a modular structure with snap-in assembly contributing to the function to which it is designed with advantages and characteristics that are disclosed in detail thereafter.

The object of this invention refers to a modular structure of demountable parts that is distinguished in that it comprises an assembling element that is structurally configured to allow the junction between two or more parts of the modular structure, simple by snap-in, advantageously avoiding the need to use tools, therefore the said element comprises recesses defined between two substantially parallel walls with a protrusion dimensioned to fit in a complementary perforation provided at the corner of the modular part to be joined that allows the entrance of the modular part to be joined but, once it entered, it avoids its exit, such an internal wedge-shaped protrusion.

In other words, when the modular part to be joined with the complementary perforation provided at a corner is inserted between the essentially parallel walls of the assembling element, the protrusion allows the entrance of the modular part until the protrusion of the assembling element is tightly fitting in the complementary perforation of the modular part. To disengage the modular part with respect to the assembling element, it shall be sufficient to press on the protrusion through an opening or a cut pierced coinciding with it in the wall opposite to the protrusion of the assembling element.

In addition, alternatively, the part can be the one incorporating the protrusion that fits in a perforation of the assembling element.

This way, the assembly element allows to join, preferably perpendicularly, successive modular parts, for example panels, to mount dismountable structures of different type, for example, shelves, construction games, etc.

### FIELD OF APPLICATION OF THE INVENTION

The field of application of this invention is within the sector of the industry engaged in the manufacture of accessories for dismountable modular structures, particularly focusing on the snap-in elements for that type of structure, encompassing sectors such as that of furniture, toys, structures for pets or others.

### BACKGROUND OF THE INVENTION

In the market, different types of dismountable modular structures are known that are joined to each other to form every type of elements.

In general, these structures, for example, based on panels, use to be mounted by joining the different parts by screwing them, for which the use of tools is required, in addition to the screws and nuts themselves, as well as spending enough time to carry out mounting or dismounting each junction, as each of the screws has to be screwed.

In addition, depending on the material of which they are made, the panels themselves shall be little reusable due to the holes successive screwing will leave.

Other systems of dismountable modular structures that can be found, that seeks a quick mounting, are systems that are simply assembled with elements.
that exert some pressure, for example, based on lugs, but that are easily loosened and released, providing little stability when the structure has a given size.

The objective of this invention, therefore, is to provide an improved snap-in assembling system to join parts of modular structures without using tools is required and that allows easily mounting and dismounting them, and without damaging them, it can be pointed out that, at least the applicant is not aware of the existence of any other assembling element nor any other invention having a similar application, that presents technical and structural characteristics same or similar to those the herein claimed possesses.

### EXPLANATION OF THE INVENTION

The modular structure with snap-in assembly that the invention proposes is configured as the suitable solution to the above-mentioned objective, the characterizing details making it possible and that duly distinguish it appearing in the final claims attached to this description.

Concretely, what the invention proposes, as it was said before, is a modular structure of dismountable parts that is distinguished in that it comprises one or more parts to be joined with, at least, one perforation and one or more assembling elements structurally configured to allow the junction, simply by snap-in, of a protrusion provided in the said element with the perforation of one, two or more of those parts of the modular structure, preferably flat parts or panels, as well as to allow and easily further disengage or dismount the parts without using any type of tool is required.

For this, the said element is constituted by a body that comprises narrow recesses, defined by the space existing between two walls substantially parallel to each other, inside which a protrusion appears, preferably wedge-shaped, which is dimensioned to tightly fit in a complementary perforation provided to that effect in an area of the modular part to be joined, close to its edge and that, in turn, is tightly fitting between the walls that define the recess, so that, when inserting the said area of the modular part to be joined in the recess of the assembling element and pressing to overcome the thickness that the protrusion determines, making that the said protrusion fit in the said perforation, the part remains locked by the said protrusion and, consequently, remains tightly joined to the assembling element.

It is important to point out that the protrusion fitting inside the recess of the assembly element in the perforation of the part to be joined shall preferably occur thanks to the fact that the inclined surface of the protrusion is oriented with its less high part towards the external part of the recess, so that, when inserting the part from that external part with its edge, a push occurs on the said inclined surface provoking the deformation of the material in the wall of the assembling element that incorporates the protrusion until it is exceeded and remains coincident with the perforation, a moment when the pressure will no longer exist and it will return to its initial shape.

In addition, it shall be easily identifiable that the junction correctly occurred when hearing a click produced when exceeding the higher point of the protrusion and this later penetrating in the perforation.

On its side, to achieve dismounting the part, on the wall of the assembling element opposite to the one incorporating the protrusion, coinciding with the position of the said protrusion, the existence of an opening has been provided adapted to allow inserting a finger and be able to exert pressure through it and through the perforation of the part inserted in the recess on the protrusion, so that, thanks to the said pressure, the material of the wall with the protrusion slightly collapses and this latter can go out of its embedment in the perforation, allowing at that point to pull the part out of the recess and, consequently, to separate the part of the assembling element also without using tools is required. However, the possibility is not discarded of being able to use some instrument, for example, a small stick, to press on the protrusion instead of the finger, especially if the thickness of the modular part requires it so.

Preferably, the protrusion inside the recess of the assembling element and the perforation of the area close to the edge of the part in which it snap-in have a circular configuration. And, likewise, in the preferred embodiment, the opening of the assembling element provided in the wall opposite to the protrusion to allow the disengagement of the protrusion, also has a circular configuration.

On the other hand, in a preferred embodiment, the recess described defined by the space existing between the two substantially parallel walls of the assembling element presents a corner-shaped configuration, being adapted to receive a corner of the modular part to be joined close to which the perforation was provided were the protrusion is fitted.

In turn, in an alternative embodiment of the modular structure of the invention, it can be the part or parts to be joined that possess, at least, one protrusion and the assembling element or elements those that are configured to include a perforation in one or more recesses to allow the junction, simply by snap-in of the parts of the modular structure and allow their further easy disengagement or dismounting, without any type of tool use being required.

Anyway, the assembling element can possess multiple recesses arranged on different planes, preferably perpendicular, to be able to join multiple modular parts.

This way, the assembling element allows to join, preferably perpendicularly, successive modular parts, especially panels, to mount dismountable structures of different types, for example shelves, furniture, display stands, construction games for children, game structures for cats or other pets, etc. contemplating in each case the use of a suitable material to stand the strains required, as well as different types of finish.

The advantage of the assembling element of the structure object of this invention is suppressing any type of tool or accessory (screwdriver, hammer), as it operates with a single snap-in, without having to use a great effort because the two parts fit perfectly.

In addition, it is a system of easy union and funny mounting thanks to the click sound that warns of the correct placement and that indicates that it can be passed to the following assembly being fully sure that the recently placed is perfectly fit and fixed.

In conclusion, it is a system so easy to mount and dismount that even a child can do, therefore, a possible application of the assembling element contemplates the construction games for children.

### DESCRIPTION OF THE DRAWINGS

To complement the description being carried out and in order to assist to best understand the characteristics of the invention, attached to this specification, as an integral part thereof, there is a set of drawings in which, for illustration and no limitation purpose, the following has been represented:

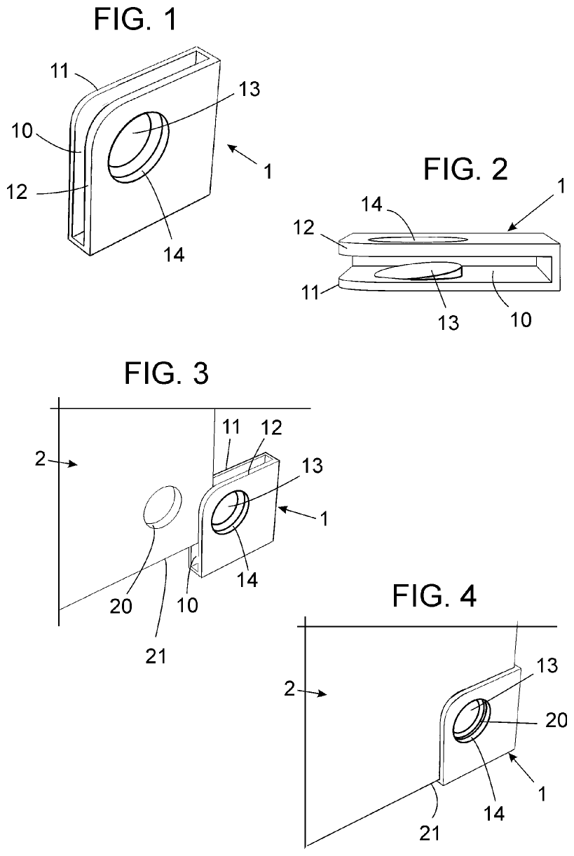

The FIGS. 1 and 2.—They show both side perspective and top plan views, respectively, of an example of embodiment of the assembling element that comprises the modular structure object of the invention, in a basic variant thereof, its configuration and essential parts can be seen;

the FIGS. 3 and 4.—They show both perspective views of the coupling steps of the assembling element with the perforated corner of part of modular structure of the invention, the manner of inserting it in the recess of the protrusion, in this case wedge-shaped, can be seen;

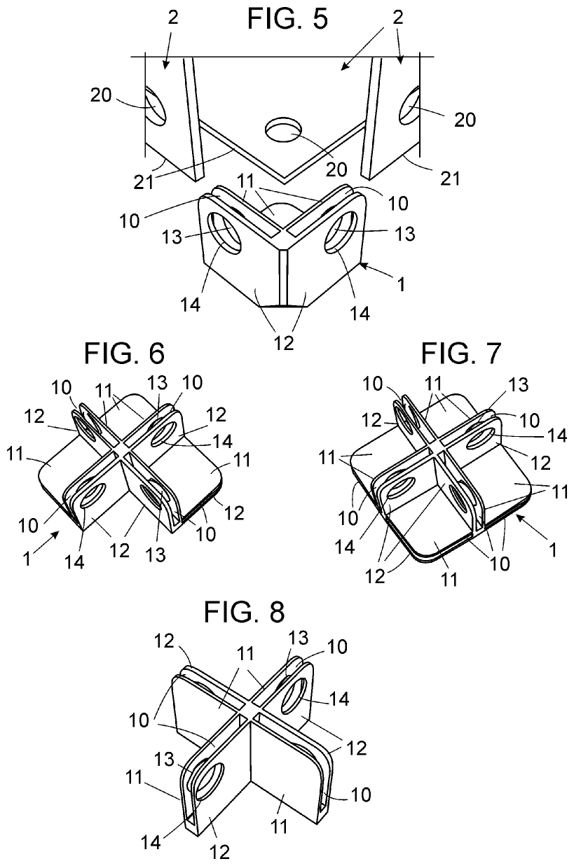

the FIG. 5.—It shows a perspective view of another example of a portion of the modular structure with assembly by snap-in, object of the invention, in this case, an example with assembling element provided with three perpendicular recesses in three different plans of the space showing the corners of the three modular parts that allows to join them;

the FIGS. 6, 7 and 8.—They show respective perspective views of three other options of embodiment of the assembling element of the modular structure of the invention with different number of recesses with protrusion;

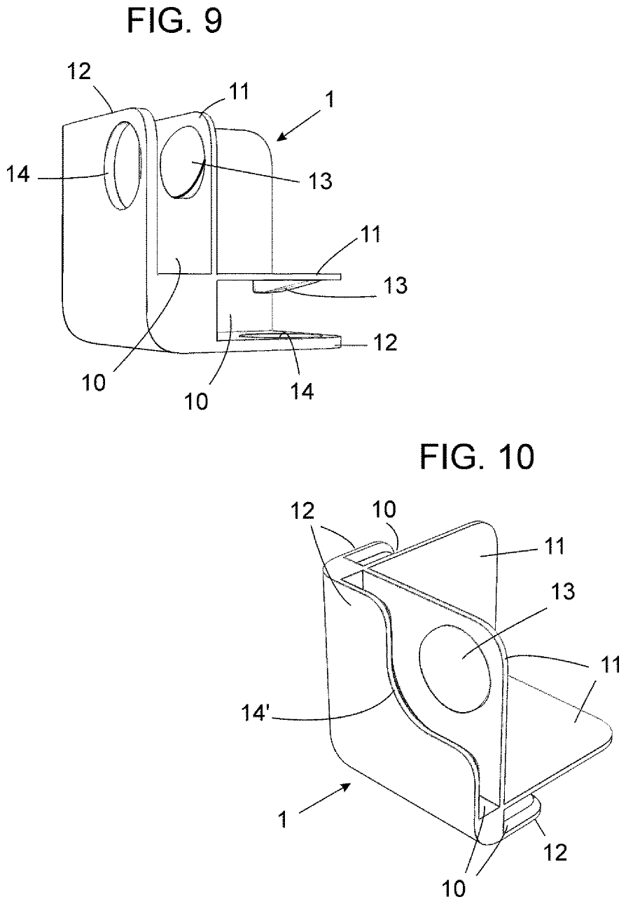

the FIG. 9.—It shows a perspective view of another example of the assembling element of the modular structure of the invention, in this case with recesses having a larger width;

the FIG. 10.—It shows a perspective view of another example of the assembling element of the modular structure of the invention, in this case with an open cut instead of a through opening in the wall opposite to the protrusion to insert the finger or another dismounting element;

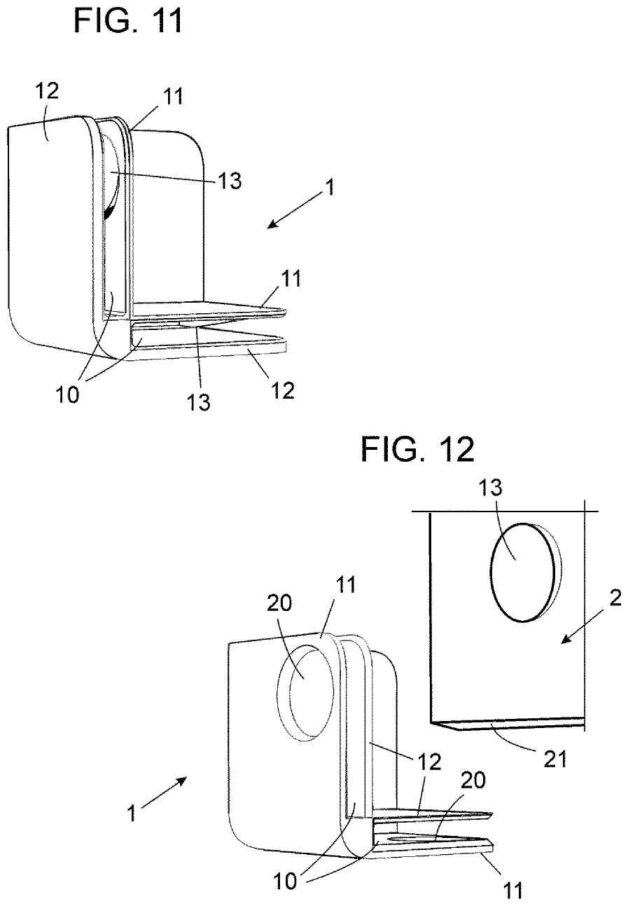

the FIG. 11.—It shows a perspective view of another example of the assembling element of the modular structure of the invention, in this case with the wall opposite to the blind protrusion, that means, without opening nor cut to insert the finger or another dismounting element;

the FIG. 12.—It shows a perspective view of another example of the modular structure of the invention, in this case with the protrusion in the part to be joined and the perforation in the assembling element; and

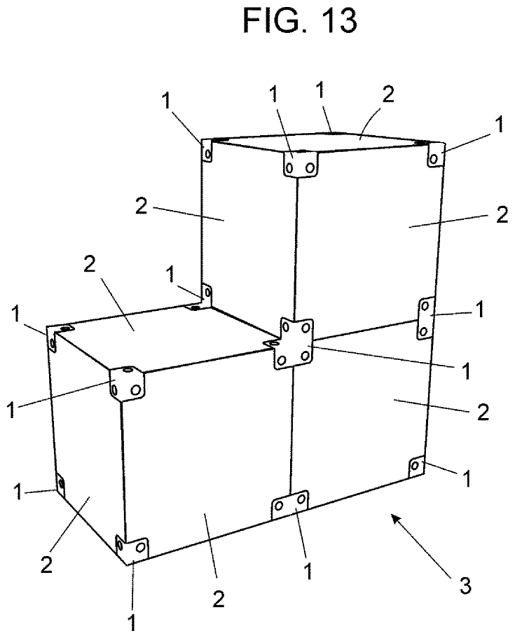

the FIG. 13.—It shows a perspective view of an example of embodiment of the modular structure with assembly by snap-in according to the invention, in this case represented after it was mounted.

### PREFERRED EMBODIMENT OF THE INVENTION

Seen the said figures, and according to the numerals adopted, non-limiting examples of embodiment of the modular structure by snap-in of the invention can be seen, which comprises what is described in detail below.

As it can be seen in the said figures, the modular structure (3) of the invention comprises:
one or more modular parts (2) to be joined that possess, at least, a perforation (20) or with a protrusion (13) located close to one of its edges (21); and
one or more assembling elements (1) provided with, at least, one recess (10) with, at least, a protrusion (13) or an internal perforation (20) in which the perforation (20) or the protrusion (13) of the modular part or parts (2) complementarily fit when inserting it by the edge (21) in the said recess (10), so that the complementary fitting of the protrusion (13) of the element (1), or of the part (2) in the perforation (20) of the part (2) or of the element (1) allows to join the part or parts (2) by snap-in to the assembly element or elements (1) without using tools.

In a preferred embodiment, the modular part or parts (2) to be joined are those possessing at least, one perforation (20) close to one of its edges (21) and the assembling element or elements (1) are those that are provided with, at least, an internal protrusion (13) in the, at least, one recess (10) to join the part or parts (2) by snap-in of the said protrusion (13) in the perforation (20), as it is shown in the examples of the FIGS. 1 to 11.

However, as it can be seen in the FIG. 12, in an alternative embodiment, the modular part or parts (2) to be joined are those that possess, at least, a protrusion (13) close to one of its edges (21) and the assembling element or elements (1) are those that are provided with, at least, one internal perforation (20) in, a least, one recess (10).

In any case, preferably, the modular part or parts (2) are flat, at least in part, and the assembling element (1) is constituted by a body that comprises one, two or more recesses (10) defined by the space existing between two walls (11,12) substantially parallel to each other of the said body, inside of which it possesses, at east, one protrusion (13) or a perforation (20).

Preferably, the said protrusion (13) is defined by a wedge having an inclined surface which, when it is in the assembling element (1), emerges in the internal face of a first wall (11) oriented with the less high part towards outside the recess (10) and, when it is in the modular part (2), it emerges from the surface of one of its faces oriented with the less high part towards the edge (21).

Anyway, the protrusion (13) is dimensioned to tightly fit in, at least, one complementary perforation (20). And the said perforation (20) or protrusion (13) shall be provided in a flat area of the modular part (2) to be joined close to its edge (21), an area that, in turn, fit tightly between the walls (11, 12) that define the recess (10) of the body of the assembling element (1) and when it is inserted in the said recess (10) pressing to overcome the high surface of the protrusion (13), the perforation (20) remains coinciding with the said protrusion (13) and this latter remains fitted in the perforation (20) provoking the junction of the modular part (2) with the body (1) of the assembling element.

Preferably, when the modular part (2) is inserted between the walls (11, 12), some of the walls (11,12), preferably the wall (11) with the protrusion (13), shall be temporarily deformed, that means it shall bend, to overcome the high surface of the protrusion (13) and thus allowing the modular part (2) passes.

In addition, in a second wall (12) of the assembling element (1) or wall opposite to the first wall (11) that incorporates the protrusion (13), coinciding with the position of the said protrusion (13), the existence of an opening (14) has been provided adapted to allow inserting a finger or other element and be able to exert pressure through it or through the perforation (20) of the part (2) inserted in the recess (10) on the protrusion (13), to achieve dismounting the part (2) without the use of tools is required.

Optionally, as it can be seen in the FIG. 10, in the second wall (12) of the assembling element (1) opposite to the first wall (11), instead of the said opening (14), an open cut (14′) has been provided that encompasses, at least, the position of the protrusion (13), allowing also and in an easier manner to insert a finger or another element and be able to exert pressure through the perforation (20) of the part (2) inserted in the recess (10) on the protrusion (13), to achieve dismounting the part (2) without using tools.

Anyway, preferably, the protrusion (13) inside the recess (10) of the assembling element (1) and the perforation (20) of the area close to the edge (21) of the part (2) to be joined in which the said protrusion (13) snaps-in are in both cases elements having a circular configuration.

Likewise, in a preferred embodiment, the opening (14) of the assembling element (1) provided in the wall (12) opposite to the protrusion (13) to press on it and achieve the disengagement from the perforation (20) of the part (2), has also a circular configuration.

Anyway, in a preferred embodiment, the recess or recesses (10) of the assembling element (1) defined or not by the space existing between the two substantially parallel walls (11, 12), that preferably are all identical, present a slot-like narrow configuration and internally having the shape of a corner, adapted to tightly fit receive an area with edge (21) in the corner of a modular part (2) where, preferably, a perforation has been provided (20) complementary to the protrusion (13) inside it; although, as it was said, it can be the opposite, that means, the protrusion (13) in the part (2) and the perforation (20) in the recess (10) of the assembling element (1).

On the other hand, optionally, the assembling element (1) can present multiple recesses (10), preferably, from multiple pairs of walls (11, 12) substantially parallel, arranged by pairs on different planes that define respective recesses (10) arranged, in turn, on different planes, preferably on perpendicular planes between adjacent pairs, as it can be seen in the examples of the FIGS. 5 to 12, allowing thus to join multiple modular parts (2) and form all types of structures (3) of different kind, such as for example the one appearing in the FIG. 13 where, in a non-limiting embodiment, the modular parts (2) are quadrangular panels.

In addition, although in preferred embodiment, when it possesses several, all the recesses (10) of the assembling element (1) are identical, in other embodiments, the said recesses (10) can have a different width (a).

Last, it shall be pointed out that the body forming the assembling element (1) can be made of different materials, depending on the type and size of the structure to which it is designed. In addition, it can be constituted by a monobloc part of a same material or by several parts, of a same or different material, joined in turn, integral to each other, anyway with the necessary strength to stand the strains of the type of modular structure (3) to which it is designed.

On their side, the panels (2) to be joined with the assembling element (1), preferably, consist of flat or laminar parts having a quadrangular or polygonal configuration, of any material, with one or more perforations (20) or protrusions (13) in one, several or all its areas of edges (21) with corners, being applicable, for example and without that means a limitation, to form a modular structure (3) that can consist of a shelves furniture, a cubic furniture, in a children construction game or in a game structure for pets.

Sufficiently disclosed the nature of this invention, as well as the manner of implementing it, it is not deemed necessary to extend anymore its explanation in order that any person skilled in the art understands its extends and the advantages arising from it.

1. A modular structure with snap-in assembly characterized in that it comprises:
one or more modular parts (2) to be joined that possess, at least, a perforation (20) or a protrusion (13) located close to one of its edges (21); and
one or more assembling elements (1) provided with, at least, one recess (10) with, at least, one protrusion (13) or an internal perforation (20) in which the perforation (20) or the protrusion (13) of the modular part or parts (2) complementarily fit when inserting it by the edge (21) in the said recess (10), so that the complementary fitting of the protrusion (13) in the perforation (20) allows to join the part or parts (2) by snap-in to the assembling element or elements (1) without using tools.

2. The modular structure with snap-in assembly according to claim 1 characterized in that:
the modular part or parts (2) to be joined possess, at least, a perforation (20) closes to one of its edges (21); and
the assembling element or elements (1) are provided with, at least, a recess (10) with, at least, an internal protrusion (13).

3. The modular structure with snap-in assembly according to claim 1 characterized in that:
the modular part or parts (2) to be joined possess, at least, a protrusion (13) closes to one of its edges (21); and
the assembling element or elements (1) are provided with, at least, a recess (10) with, at least, an internal perforation (20).

4. The modular structure with snap-in assembly according to claim 2 characterized in that the modular part or parts (2) are flat, at least in part, close to the edge (21) where they incorporate the perforation (20) or the protrusion (13) and the assembling element (1) is constituted from a body that comprises one, two or more recesses (10) defined by the space existing between two walls (11,12) substantially parallel to each other of the said body, inside which it possesses, at least, one protrusion (13) or a perforation (20).

5. The modular structure with snap-in assembly according to claim 4 characterized in that the said protrusion (13) is defined by a wedge having an inclined surface which, when it is in the assembling element (1), the said wedge emerges in the internal face of a first wall (11) oriented with the less high part towards outside the recess (10) and, when it is in the modular part (2), the wedge emerges from the surface of one of its faces oriented with the less high part towards the edge (21).

6. The modular structure with snap-in assembly according to claim 4 characterized in that the protrusion (13) is dimensioned to tightly fit in, at least, one complementary perforation (20); and that a flat area of the modular part (2) tightly fit between the walls (11, 12) that define the recess (10) of the body of the assembling element (1).

7. The modular structure with snap-in assembly according to claim 2 characterized in that in a second wall (12) of the assembling element (1) opposite to the first wall (11) coinciding with the position of the protrusion (13) the existence of an opening (14) has been provided adapted to allow inserting a finger or other element and be able to exert pressure through it or through the perforation (20) of the part (2) inserted in the recess (10) on the protrusion (13), to achieve dismounting the part (2) without the use of tools is required.

8. The modular structure with snap-in assembly according to claim 2 characterized in that in the second wall (12) of the assembling element (1) opposite to the first wall (11), an open cut (14′) has been provided that encompasses, at least, the position of the protrusion (13), allowing to insert a finger or another element and be able to exert pressure through the perforation (20) of the part (2) inserted in the recess (10) on the protrusion (13), to achieve dismounting the part (2) without using tools.

9. The modular structure with snap-in assembly according to claim 1 characterized in that the protrusion (13) and the perforation (20) have a circular configuration.

11. The modular structure with snap-in assembly according to claim 1 characterized in that the recess or recesses (10) of the assembling element present a slot-like narrow configuration and internally having the shape of a corner, adapted to tightly fit receive an area with edge (21) in the corner of a modular part (2).

12. The modular structure with snap-in assembly according to claim 1 characterized in that the assembling element (1) possesses multiple recesses (10) arranged on different planes.

13. The modular structure with snap-in assembly according to claim 1 characterized in that when it has several, all the recesses (10) of the assembling element (1) are identical.

14. The modular structure with snap-in assembly according to claim 1 characterized in that, when it has several, some recesses (10) of the assembling element (1) have a different width (a).

15. The modular structure with snap-in assembly according to claim 1 characterized in that the panels (2) are constituted by flat or laminar parts having a quadrangular or polygonal configuration with one or more perforations or protrusions (13) in one, several or all their areas of edge (21) with corners (a).

16. (canceled)

17. The modular structure with snap-in assembly according to claim 4 characterized in that in a second wall (12) of the assembling element (1) opposite to the first wall (11) coinciding with the position of the protrusion (13) the existence of an opening (14) has been provided adapted to allow inserting a finger or other element and be able to exert pressure through it or through the perforation (20) of the part (2) inserted in the recess (10) on the protrusion (13), to achieve dismounting the part (2) without the use of tools is required.

18. The modular structure with snap-in assembly according to claim 4 characterized in that in the second wall (12) of the assembling element (1) opposite to the first wall (11), an open cut (14′) has been provided that encompasses, at least, the position of the protrusion (13), allowing to insert a finger or another element and be able to exert pressure through the perforation (20) of the part (2) inserted in the recess (10) on the protrusion (13), to achieve dismounting the part (2) without using tools.
